(19) United States
(12) Patent Application Publication
(10) Pub. No.: US 2008/0064232 A1
(43) Pub. Date: Mar. 13, 2008

(54) INTEGRATED DEVICE

(75) Inventors: Werner Reiss, Bad Feilnbach (DE); Wolfgang Hetzel, Nattheim (DE); Florian Ammer, Ergoldsbach (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: Qimonda AG, Munich (DE)

(21) Appl. No.: 11/742,250

(22) Filed: Apr. 30, 2007

(30) Foreign Application Priority Data
Sep. 12, 2006 (DE) 10 2006 042 774.2

(51) Int. Cl. H01R 12/00; G11B 33/02

(52) U.S. Cl. 439/66; 29/592.1; 369/75.11

(57) ABSTRACT

An integrated device is disclosed. In one embodiment, the integrated device includes a carrier substrate with a through hole and a contact sleeve. A circuit chip is provided with a contact pad above the carrier substrate. A conductive material electrically connects the contact pad to the contact sleeve.

### CROSS-REFERENCE TO RELATED APPLICATIONS

This Utility patent application claims priority to German Application No. DE 10 2006 042 774.2-33, filed Sep. 12, 2006, which is herein incorporated by reference.

### BACKGROUND

Upon increasing the integration of current integrated circuits and upon optimizing production efficiency, also packaging and processing of integrated circuits have become a focus of industrial research and development. Conventional bonding techniques thereby provide an electric connection between an integrated circuit and a carrier, in which, for example, an electrical connection between contact pads of a semiconductor chip and corresponding equivalents of a carrier substrate are sequentially fabricated by using bonding a wire. However, such bonding not only is error-prone but further requires a lot of time and that a substantial volume of the packaging is reserved for the wires.

As a substantial progress in this field, the flip chip technology may be noted, in which a semiconductor substrate is directly connected to a carrier substrate. In this alternative conventional technology, contact pads are provided on the semiconductor chip, which are directly soldered to corresponding contact pads of a carrier substrate. Thereby, portions of a solder material are applied to the contact pads and the semiconductor chip is positioned headfirst on the carrier substrate such that contact pads of the semiconductor chip face the contact pads of the carrier substrate. Thereafter, the arrangement is heated, thus soldering the contact pads facing each other. Apart from a substantial simplification of the process, this method also allows for an optimized utilization of available space and thus also for a higher integration and smaller IC-packages.

Although the aforementioned bonding using bond wires may have disadvantages, but, nevertheless, bonding allows for a later inspection of the contact, and, in the case of a faulty contact, also for a respective reworking of the contact. As far as inspecting and/or reworking is concerned, this may be more difficult or even impossible using flip-chip technology. Although an electronic functionality check as well as an optical examination using X-rays is known, a correction or a reworking of faulty contacts may often be impossible. Moreover, quality control using X-rays may cause damage to the sensitive semiconductor structures, thus, again, resulting in a diminished process yield.

For these and other reasons there is a need for the present invention.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIGS. 1A through 1C illustrate schematic views of the fabrication of a contacting according to a first embodiment.

FIGS. 2A trough 2C illustrate schematic views of the fabrication of a contacting according to a second embodiment.

FIGS. 3A trough 3C illustrate schematic views of the fabrication of a contacting according to a third embodiment.

FIGS. 4A trough 4C illustrate schematic views of the fabrication of a contacting according to a fourth embodiment.

FIG. 5 illustrates a schematic view of an integrated device having a contacting according to a fifth embodiment.

FIG. 6 illustrates a schematic view of an integrated device having a contacting according to a sixth embodiment.

FIG. 7 illustrates a schematic view of an integrated device having a contacting according to a seventh embodiment.

FIGS. 8A through 8D illustrate schematic views of a memory module according to an eighth, ninth, and tenth embodiment.

FIGS. 9A and 8B illustrate schematic views of a graphics adaptor according to an eleventh embodiment.

FIGS. 10A and 10B illustrate schematic views of a circuit system according to a twelfth embodiment.

### DETAILED DESCRIPTION

In the following Detailed Description, reference is made to the accompanying drawings, which form a part hereof, and in which is illustrated by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Various embodiments of the present invention may provide particular advantages for an improved integrated device, an improved memory device, an improved memory module, an improved circuit system, and an improved method for fabricating an electrical contacting.

One embodiment provides an integrated device that includes a carrier substrate, the carrier substrate including a through hole and a contact sleeve, the contact sleeve being arranged such that an opening of the contact sleeve and the through hole at least in part overlap; a circuit chip above the carrier substrate, the circuit chip including a contact pad on a surface facing the carrier substrate, the contact pad being arranged such that the contact pad and the opening of the contact sleeve at least in part overlap; and a conductive material, the conductive material electrically connecting the contact pad to the contact sleeve.

One embodiment provides a memory device having a carrier substrate, the carrier substrate including a through hole and a contact sleeve, the contact sleeve being arranged such that an opening of the contact sleeve and the through hole at least in part overlap; an integrated memory circuit above the carrier substrate, the integrated memory circuit including a contact pad on a surface facing the carrier substrate, the contact pad being arranged such that the contact pad and the opening of the contact sleeve at least in part overlap; and a conductive material, the conductive material electrically connecting the contact pad to the contact sleeve.

One embodiment provides a memory module including a circuit board, the circuit board including a through hole and a contact sleeve, the contact sleeve being arranged such that an opening of the contact sleeve and the through hole at least in part overlap; an integrated memory circuit above the circuit board, the integrated memory circuit including a contact pad on a surface facing the circuit board, the contact pad being arranged such that the contact pad and the opening of the contact sleeve at least in part overlap; and a conductive material, the conductive material electrically connecting the contact pad to the contact sleeve.

One embodiment provides a circuit system including a circuit board, the circuit board including a through hole and a contact sleeve, the contact sleeve being arranged such that an opening of the contact sleeve and the through hole at least in part overlap; an integrated circuit chip above the circuit board, the integrated circuit chip including a contact pad on a surface facing the circuit board, the contact pad being arranged such that the contact pad and the opening of the contact sleeve at least in part overlap; and a conductive material, the conductive material electrically connecting the contact pad to the contact sleeve.

One embodiment provides a method for fabricating an electrical contacting of an integrated circuit to a carrier substrate includes the processes of providing an integrated circuit including a contact pad on a surface of the integrated circuit; providing the carrier substrate with a through hole; providing a contact sleeve such that an opening of the contact sleeve and the through hole at least in part overlap; stacking the integrated circuit on the carrier substrate such that the contact pad and the opening of the contact sleeve at least in part overlap; and contacting the contact pad to the contact sleeve.

Embodiments may allow for the contacting of a contact pad of a chip to a contact sleeve of a carrier as well as for an inspection of the contact, and, if required, a reworking or correction of a faulty contact. By using the through hole of the carrier and the at least partial overlapping of the aperture of the through hole with the contact pad of the chip, the electrical contacting is accessible from one side even after the stacking of the chip on the carrier.

According to one embodiment, it is furthermore possible to increase the number of electrical contacts of a chip with a carrier, while maintaining the available area, thus achieving a high pitch.

According to one embodiment, a projecting contact is provided on the contact pad of the chip or circuit is carried out prior to stacking the chip or circuit on the carrier, such as a carrier substrate or a circuit board. During stacking, the projecting contact is at least partially inserted into the through hole of the carrier. A correct alignment of the chip or circuit relative to the carrier may be guaranteed by the mechanical locking of the projecting contact into the sleeve. Furthermore, an improved breaking strength may result in a better bonding of the projecting contacts of the chip to the carrier. Additional carrier layers, such as an under-fill layer, may be rendered obsolete. Furthermore, the material of the projecting contacts may have a thermal expansion which is in a range of the thermal expansion of the carrier material. This enables an advantageous joining of the chip or circuit and the carrier in a manner resistive to stress caused by temperature changes.

According to another embodiment, the contacting of the contact pad with the contact sleeve is carried out by welding. By using welding, a material of the involved components may be liquefied and coalesce. The solidified coalesced material then forms the conductive material and it may be not necessary to add any further material, such as solders, conductive pastes, or welding fillers. The welding may be carried out by using laser welding or ultrasonic welding.

According to another embodiment, the contacting of the contact pad is carried out by welding the projecting contact to the contact sleeve. Thereby, a projecting contact at least partially intrudes into the sleeve from a top side, while a contacting remains accessible from a bottom side.

According to another embodiment of the present invention, the contacting of the contact pad with the contact sleeve may be carried out by at least partially filling the through hole with a soldering metal. The chip is stacked onto the carrier from a top side while the sleeve is accessible from the bottom side and may be filled with solder from this side, e.g., by utilizing capillary and/or wetting forces. This may e.g., be carried out by using wave soldering, whereby liquid solder material penetrates the contact sleeve and forms the contacting.

According to another embodiment, an inspection of the contacting of the contact pad to the contact sleeve may be carried out after contacting, and, in the case of a faulty contacting, a renewed contacting may take place. The chip or circuit is stacked onto the carrier substrate or circuit board from a top side, and the contacting remains accessible from a bottom side via the contact sleeve and may therefore be directly inspected, examined, optically viewed and reworked. The contacting may be corrected e.g., by a renewed welding or soldering, optionally adding a further conductive material.

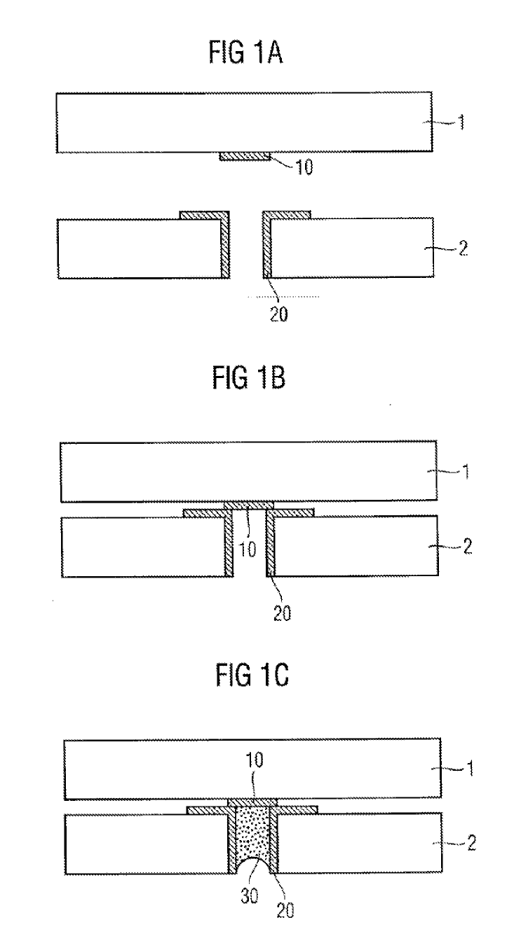

FIGS. 1A through 1C illustrate schematic views of the fabrication of a contacting according to a first embodiment. FIG. 1A illustrates a circuit chip 1 including a contact pad 10 and a carrier substrate 2 having a through hole and a contact sleeve 20 arranged therein. The circuit chip 1 may thereby include a semiconductor substrate with an integrated circuit and/or functional electronic and/or optical entities, such as transistors, resistors, capacitors, diodes, conductive lines, light emitting entities, and/or sensor entities. Integrated circuits usually include a manifold of functionalized entities and areas, such as conductors, insulators, semiconductors, diffusion barriers, doped regions, and/or dielectric structures. As materials, e.g., silicon or other materials conventional in the semiconductor industry may be used. The contact pad 10 is thereby electrically connected to one of the functional entities.

The carrier substrate 2 may e.g., be a chip carrier or also a printed circuit. The contact sleeve 20 usually includes a conductive material and for example includes one of the metals copper, gold, tin, lead, silver, antimony, aluminum or bismuth. The contact sleeve 20 may be provided by using electrically supported coating techniques, such as plating, or by using other methods for depositing metal layers frequently used in semiconductor technology.

FIG. 1B illustrates the circuit chip 1 stacked onto the carrier substrate 2. Thereby, an aperture of the through hole of the carrier substrate 2 overlaps at least partially with the contact pad 10 of the circuit chip 1. Furthermore an opening of the sleeve 20 at least in part overlaps with the through hole. For this reason, contacting of the circuit chip 1 to the carrier substrate 2 may be accessible through the through hole of the carrier substrate 2. The contacting is carried out via a corresponding electrical contacting of the contact pad 10 to the contact sleeve 20.

FIG. 1C illustrates the circuit chip 1 on the carrier substrate 2, whereby the contact pad 10 of the circuit chip 1 is contacted with the contact sleeve 20 of the carrier substrate 2 by using a conductive material 30. The conductive material 30 may include a metal solder or a conductive glue, and thus include e.g., one of the metals copper, gold, tin, lead, silver, antimony, aluminum or bismuth.

The fabrication of the electrical contacting according to this embodiment of the present invention not only allows for an examination of the correct alignment of the contact pad 10 relative to the apertures of the through holes of the carrier substrate 2, e.g., by using an optical inspection through the through hole prior to providing the conductive material 30, but also an examination and, if required, a reworking and correction of the contacting of the contact pad 10 to the contact sleeve 20. In this way, e.g., the effective resistance between the contact pad 10 and the contact sleeve 20 may be measured or an inspection of the first conductive material 30 may be carried out. If required, the first conductive material 30 may be removed and then re-applied, or the first conductive material 30 may be re-liquefied—further conductive materials may optionally be added—in order to provide the contacting of the contact pad 10 with the contact sleeve 20.

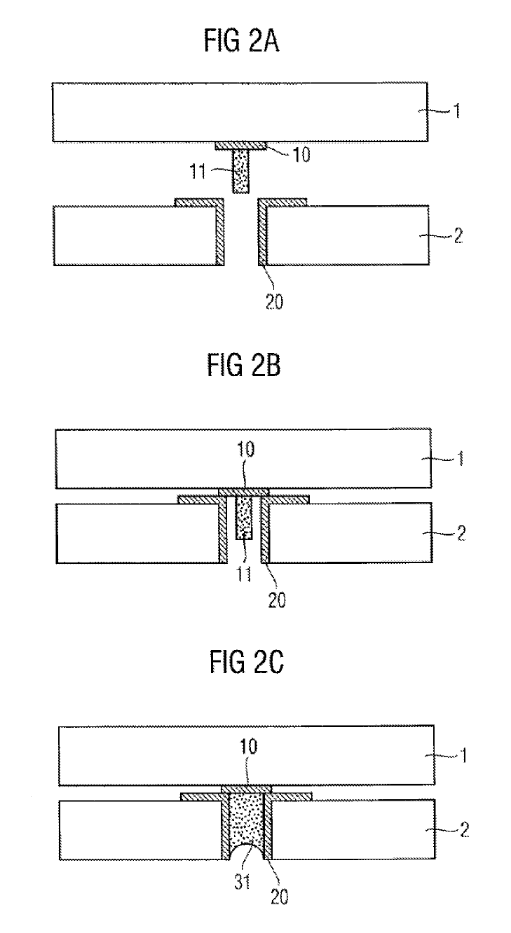

FIGS. 2A through 2C illustrate schematic views of the fabrication of a contacting according to the second embodiment. FIG. 2A illustrates the circuit chip 1 with the contact pad 10, on which a projecting contact 11 is arranged. The second embodiment of the present invention is described here as a development of the embodiment described in conjunction with FIGS. 1A through 1C. Elements having the same reference numerals in the various drawings are considered identical in the various Figures and are not described again in connection which each drawing description.

According to this embodiment, the projecting contact 11 has a smaller perimeter than that of the contact sleeve 20, such that the contact 11 at least partially intrudes into the through hole of the carrier substrate 2, as illustrated in FIG. 2B. Thereby, the material of the contact 11 may be a metal solder or a conductive glue and thus include e.g., one of the metals copper, gold, tin, lead, silver, antimony, aluminum or bismuth. Since the projecting contact 11 at least partially intrudes into the through hole of the carrier substrate 2, a correct alignment of the circuit chip 1 relative to the carrier substrate 2 may be guaranteed by this embodiment of the present invention.

As illustrated in FIG. 2C, the projecting contact 11 is liquefied, e.g., by melting, and upon solidifying forms the contacting in the form of the conductive material 31. Optionally, material may be added in which e.g., during a wave soldering process further liquid solder penetrates into the sleeve 20, melts the contact 11, coalesces with the material of the contact 11 and finally solidifies to form a contacting.

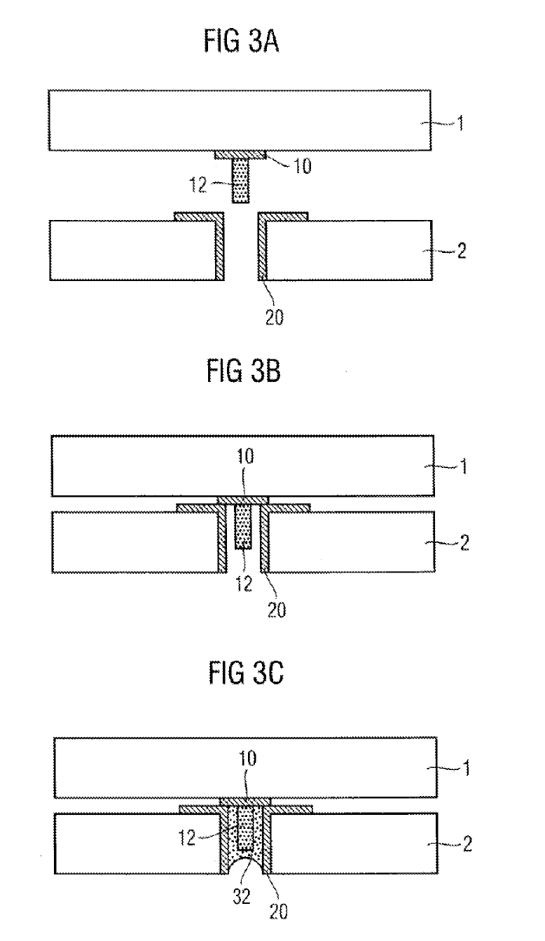

FIGS. 3A through 3C illustrate schematic views of the fabrication of a contacting according to the third embodiment. FIG. 3A illustrates the circuit chip 1 including the contact pad 10 on which a projecting contact 12 is arranged. The third embodiment of the present invention is depicted as a development of the embodiment described in conjunction with FIGS. 2A through 2C. According to the third embodiment, however, the material of the projecting contact 12 does not melt or only partially melts when a contacting is formed by using providing the conductive material 32, as illustrated in FIGS. 3B and 3C. Thereby, the contact 12 and the material 32 may include one of the metals copper, gold, tin, lead, silver, antimony, aluminum, bismuth or a combination thereof. For example, a copper or gold contact 12 may be soldered with a solder material 32, that includes, for example, tin, or it may be glued with a conductive adhesive, that includes, for example, silver, in order to contact the contact pad 10 to the sleeve 20.

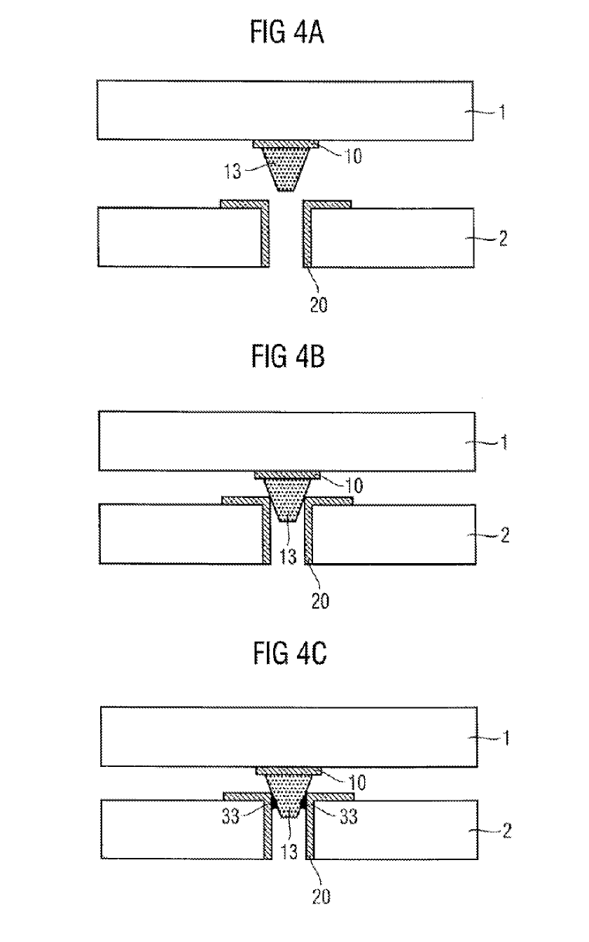

FIGS. 4A through 4C illustrate schematic views of the fabrication of a contacting according to the fourth embodiment of the present invention. FIG. 4A illustrates a circuit chip 1 with the contact pad 10, on which a projecting contact 13 is arranged. Thereby, the projecting contact 13 possesses a larger perimeter toward the contact pad 10 than away from the contact pad 10. This may, e.g., be the case for a cone-like shape, a pearl-like shape, a drop-like shape, and/or a pyramid-like shape of the contact 13. An inner perimeter of the contact sleeve 20 may be smaller than a large perimeter of the projecting contact 13.

As is illustrated in FIG. 4B, after stacking the circuit chip 1 having the contact pad 10 and the projecting contact 13 onto the carrier substrate 2 having the contact sleeve 20, the projecting contact 13 is at least partially seated along a continuous line at the contact sleeve 20. In the case of a circular aperture of the contact sleeve 20 and in the case of a cone-shaped projecting contact 13, for example, the continuous line is formed by the circle line at the aperture of the contact sleeve 20 facing the projecting contact 13. By using process-dependent variations, the actual shape of the contact 13 and/or of the sleeve 20 may illustrate irregularities resulting in a non-continuous contact line. In this case, the contact 13 may still be at least partially seated on an aperture of the sleeve 20. Furthermore, in the presence of more than one contact pad 10 on the circuit chip 1 and of more than one sleeve 20 in and/or on the carrier substrate 2, manufacturing tolerances may result in a contact 13 not touching a corresponding sleeve 20 at all. In such a case, the contacting is established by using the conductive material 33, which may bridge the gap.

The contacting of the contact pad 10 with the contact sleeve 20 via the projecting contact 13 may be carried out by using either a solder or an adhesive, generally however, as illustrated in FIG. 4C, by using a conductive material 33. According to this embodiment of the present invention, the conductive material 33 may e.g., be a metal solder or a conductive glue, or a ductile conductive material. Furthermore, in the presence of more than one contact pad 10 on the circuit chip 1 and of more than one sleeve 20 in and/or on the carrier substrate 2, manufacturing tolerances may result in a contact 13 not touching a corresponding sleeve 20 at all. In such a case, the contacting is established by using the conductive material 33, which may bridge the gap.

FIG. 5 illustrates a schematic view of an integrated device including a contacting according to the fifth embodiment of the present invention. FIG. 5 illustrates a circuit chip 1 having a contact pad 10 and a projecting contact 14, whereby the projecting contact 14 includes a weldable material. The fifth embodiment of the present invention may be understood as a development of the embodiment described in conjunction with the FIGS. 4A through 4C. A contact sleeve 21 of the carrier substrate 2 thereby includes a material which may be welded to the material of the projecting contact 14. The contacting of the contact pad 10 to the contact sleeve 21 via the projecting contact 14 may be, according to this embodiment, carried out by using weld seam 34. The weld seam 34 may therefore be produced in a continuous manner along an inner perimeter of the contact sleeve 21 or of the projecting contact 14, respectively, or also punctually. The contact 14 and/or the sleeve 21 may include one or more of the metals copper, gold, tin, lead, silver, antimony, aluminum or bismuth.

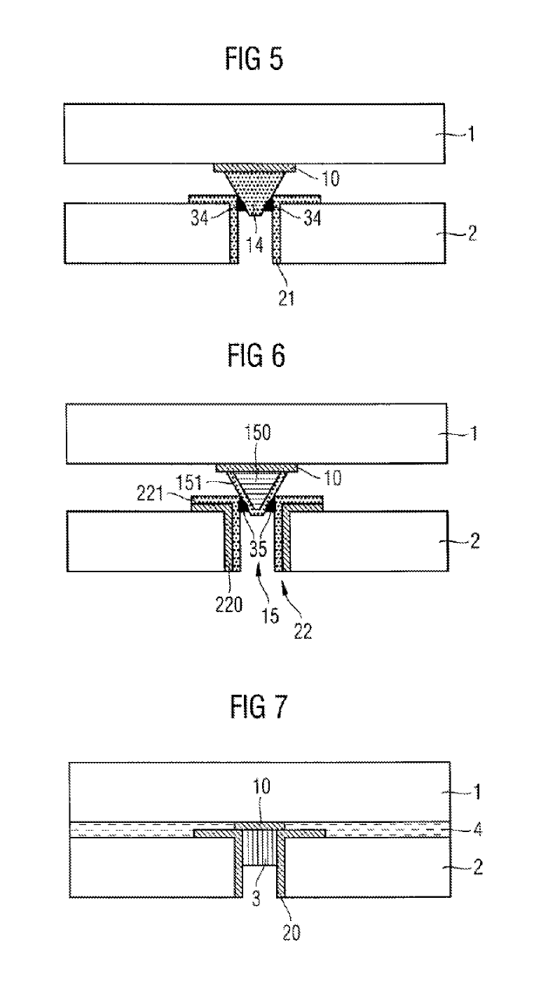

FIG. 6 illustrates a schematic view of an integrated device including a contacting according to the sixth embodiment of the present invention. FIG. 6 illustrates the circuit chip 1 including a contact pad 10 and a projecting contact 15. The sixth embodiment of the present invention may be understood as a development of the embodiment described in conjunction with FIG. 5. Thereby, the projecting contact 15 includes a projecting contact base 150 and a weldable coating 151 is arranged on the contact pad 10 and on the base 150. The contact sleeve 22 thereby includes a sleeve base 220 and a weldable coating 221. According to this embodiment, a weld seam 35 is formed between the weldable coating 151 of the projecting contact 15 and the weldable coating 221 of the contact sleeve 22. Thus, a contacting by using welding may be carried out even if the materials of the projecting contact base 150 and/or of the sleeve base 220 are not weldable or difficult to weld. In that case, the projecting contact base 150 and the sleeve base 220 may e.g., include less expensive materials, while a welding is still possible. The welding may in general be carried out e.g., by using laser welding or ultrasonic welding. The weld seam 35 may be optically inspected, and, if required, it may be extended or reworked in order to improve and/or establish the contacting. The contact 15 and the sleeve 22 may include one or more of the metals copper, gold, tin, lead, silver, antimony, aluminum or bismuth.

FIG. 7 illustrates a schematic view of an integrated device including a contacting according to the seventh embodiment of the present invention. FIG. 7 depicts the circuit chip 1 including the contact pad 10, which is stacked on the carrier substrate 2 including the contact sleeve 20. Thereby, the contacting of the contact pad 10 with the contact sleeve 20 is carried out by using a contact 3. In this embodiment of the present invention, the contact 3 represents a contact according to any one of the previously described embodiments of the present invention. The contact 3 may e.g., include a weld seam 34, 35 or a conductive material 30, 31, 32, or 33.

According to this seventh embodiment, however, the intermediate space between the circuit chip 1 and the carrier substrate 2 is filled with an intermediate layer 4. The intermediate layer 4 may thereby include an insulating material and/or support a mechanical binding of the circuit chip 1 to the carrier substrate 2. Furthermore, the intermediate layer 4 may include a molding mass and be a part of the IC package which may then at least partially envelope the circuit chip 1 as well as the carrier substrate 2. Examples for molding masses are polymers, resins and ceramics.

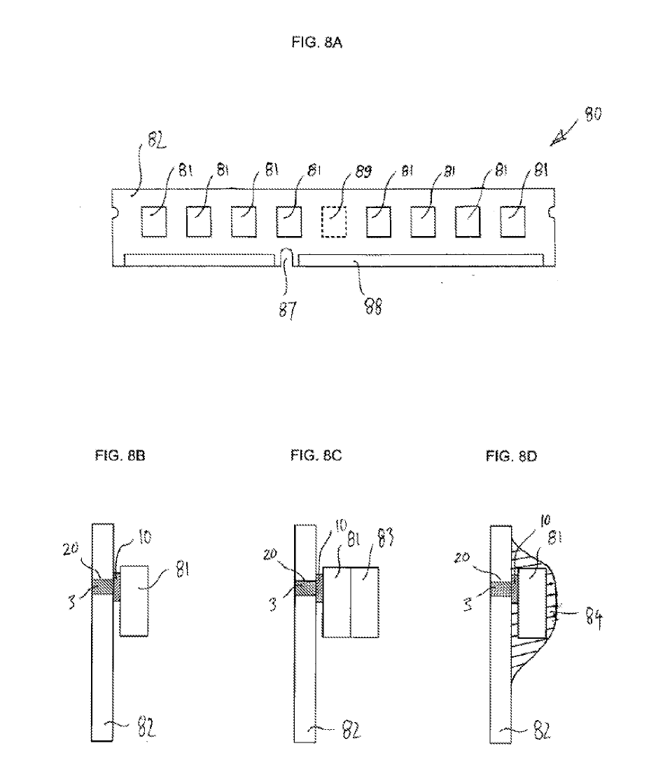

FIG. 8A illustrates a schematic top view of a memory module according to an eighth, ninth, and tenth embodiment of the present invention. According to this embodiment, a memory module 80 is provided, such as a SIMM, DIMM, or another memory module which may be connected to a circuit board. The circuit board may be a mother board of a computer system. The memory module 80 may provide memory to a circuit system, such as a computer system, video system, audio system, entertainment system, receiving system, switching system, transmitting system, or control system.

The memory module 80 includes at least one memory device 81. The memory device 81 may be arranged on a top side of a printed circuit board 82 and/or on a bottom side of the printed circuit board 82. The memory module 80 may further include additional components, for example passive or active components and/or memory controller devices, such as a memory controller 89. The printed circuit board 82 may further include a notch 87, which may guarantee a correct insertion of the memory module 80 into a respective socket. Electrical connection of the memory module 80 is achieved by using a connector 88. The connector 88 may include one or more rows of contact pads which establish electrical contact through contact springs of a respective socket. The memory devices 81 may be DRAM devices, PC-RAM devices, flash-RAM devices, SRAM devices, CB-RAM devices, resistive memory devices, magnetic memory devices, and/or other types of memory devices.

FIG. 8B illustrates a schematic side view of a memory module according to the eighth embodiment of the present invention. On the circuit board 82 there is arranged a memory device 81. The memory device 81 includes a contact pad 10 which is arranged in an area of a contact sleeve 20. The circuit board 82 includes a through hole which may hold parts of the contact sleeve 20 and may be filled, at least in part, by the contact 3. As already described in conjunction with FIG. 7, the contact 3 represents a contact according to anyone of the previously described embodiments of the present invention.

FIG. 8C illustrates a schematic side view of a memory module according to the ninth embodiment of the present invention. On the circuit board 82 there is arranged a memory device 81. The memory device 81 includes a contact pad 10 which is arranged in an area of a contact sleeve 20. The circuit board 82 includes a through hole which may hold parts of the contact sleeve 20 and may be filled, at least in part, by the contact 3. According to this embodiment of the present invention, at least one further memory device 83 is arranged above the memory device 81. The memory device 81 and the further memory device 83 may include means for a respective interconnection and a routing of signals from the further memory device 83 to the connection 3.

FIG. 8D illustrates a schematic side view of a memory module according to the tenth embodiment of the present invention. On the circuit board 82 there is arranged a memory device 81. The memory device 81 includes a contact pad 10 which is arranged in an area of a contact sleeve 20. The circuit board 82 includes a through hole which may hold parts of the contact sleeve 20 and may be filled, at least in part, by the contact 3. According to this embodiment of the present invention, the memory module includes a package 84. The package 84 may, at least in parts, envelop the memory device 81 and/or the printed circuit board 82. Furthermore, the package 84 may penetrate into a space between the memory device 81 and the printed circuit board 82. The package 84 may include a resin, a polymer, and/or a ceramic material. According to an embodiment of the present invention, the package 84 is provided in a liquid or viscous state, after the memory device 81 has been connected to the printed circuit board 82. Solidifying the liquid or viscous material, in order to provide the package 84, may include a heating stage.

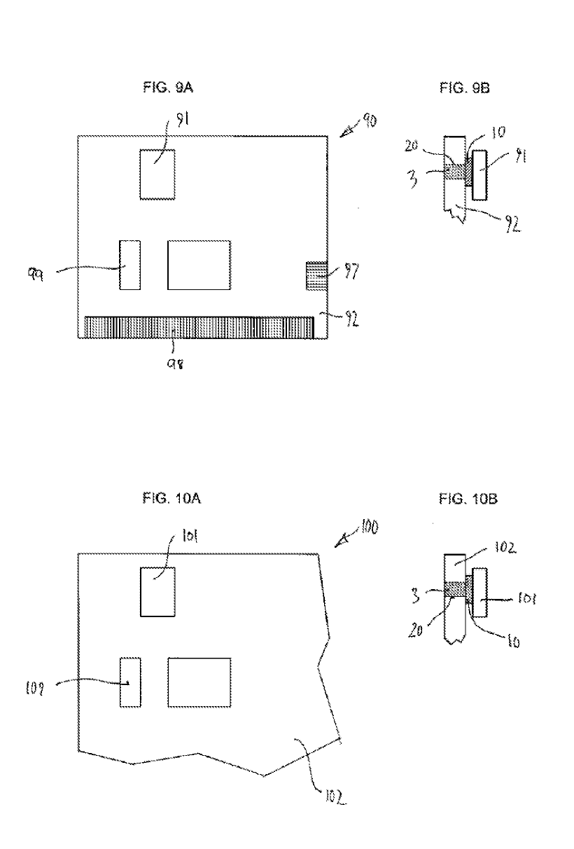

FIGS. 9A and 9B illustrate schematic views of a graphics adaptor according to an eleventh embodiment of the present invention. FIG. 9A illustrates a schematic top view of a graphics adaptor 90. The graphics adaptor 90 includes a printed circuit board 92, a connector 98 to a bus, such as to a PCI bus or to an AGP graphics bus, and a connector 97 to connect to an output device, such as to a monitor and/or to a display. The memory adaptor 90 may include a graphics processor 99 and/or other integrated or discrete devices. According to this embodiment of the present invention, the memory adaptor 90 includes at least one integrated device 91, such as a memory device, which is connected to the printed circuit board 92 according to an embodiment of the present invention.

FIG. 9B illustrates a schematic side view of the graphics adaptor according to the eleventh embodiment of the present invention. On the circuit board 92 there is arranged an integrated device 91, such as a graphics memory device or memory device. The device 91 includes a contact pad 10 which is arranged in an area of a contact sleeve 20. The circuit board 92 includes a through hole which may hold parts of the contact sleeve 20 and may be filled, at least in part, by the contact 3. As already described in conjunction with FIG. 7, the contact 3 represents a contact according to anyone of the previously described embodiments of the present invention.

FIGS. 10A and 10B illustrate schematic views of a circuit system according to a twelfth embodiment of the present invention. FIG. 10A illustrates a schematic top view of a circuit system 100. The circuit system 100 may include a printed circuit board 102 and a discrete and/or integrated device 109. According to this embodiment of the present invention, the circuit system 100 further includes an integrated circuit 101.

FIG. 10B illustrates a schematic side view of the circuit system according to the twelfth embodiment. On the circuit board 102, such as a printed circuit board or application board, there is arranged an integrated device 101. The integrated device 101 includes a contact pad 10 which is arranged in an area of a contact sleeve 20. The circuit board 102 includes a through hole which may hold parts of the contact sleeve 20 and may be filled, at least in part, by the contact 3. As already described in conjunction with FIG. 7, the contact 3 represents a contact according to anyone of the previously described embodiments of the present invention.

According to one embodiment, a contact sleeve may in parts be arranged inside a through hole of a carrier, such as a carrier substrate or a circuit board. Furthermore the contact sleeve may also be arranged only on a surface of the carrier, hence not extending into the through hole. In this case, the contact sleeve may be formed as an eye, such as a soldering eye or a terminal tag. The sleeve and/or the eye may further be discontinuous or broken, such to form a C-shape and may be furthermore broken into more than one continuous parts. Furthermore, according to the present invention a chip, an integrated circuit, a circuit chip, an integrated memory circuit, or an integrated circuit chip is contacted to a carrier substrate, a chip carrier, a printed circuit board, an application board, or to a circuit board.

Although specific embodiments have been illustrated and described herein, it will be appreciated by those of ordinary skill in the art that a variety of alternate and/or equivalent implementations may be substituted for the specific embodiments illustrated and described without departing from the scope of the present invention. This application is intended to cover any adaptations or variations of the specific embodiments discussed herein. Therefore, it is intended that this invention be limited only by the claims and the equivalents thereof.

What is claimed is:

1. An integrated device comprising:
a carrier substrate, the carrier substrate comprising a through hole and a contact sleeve, the contact sleeve being arranged such that an opening of the contact sleeve and the through hole at least in part overlap;
a circuit chip above the carrier substrate, the circuit chip comprising a contact pad on a surface facing the carrier substrate, the contact pad being arranged such that the contact pad and the opening of the contact sleeve at least in part overlap; and
a conductive material, the conductive material electrically connecting the contact pad to the contact sleeve.

2. The integrated device of claim 1, the contact sleeve comprising a coating, the coating comprising a weldable material.

3. The integrated device of claim 1, the conductive material comprising a welding seam.

4. The integrated device of claim 1, the integrated device comprising a projecting contact, the projecting contact being arranged on the contact pad and at least in part in the through hole.

5. The integrated device of claim 4, the projecting contact comprising a coating, the coating comprising a weldable material.

6. The integrated device of claim 4, the projecting contact touching the contact sleeve along a continuous line.

7. The integrated device of claim 6, the conductive material comprising a welding seam at least along a part of the continuous line.

8. The integrated device of claim 4, the projecting contact comprising at least one of the metals copper, gold, tin, lead, silver, antimony, aluminum, and bismuth.

9. The integrated device of claim 1, the contact sleeve comprising at least one of the metals copper, gold, tin, lead, silver, antimony, aluminum or bismuth.

10. The integrated device of claim 1, the through hole being at least partially filled with the conductive material.

11. The integrated device of claim 10, the conductive material comprising a soldering metal.

12. The integrated device of claim 10, the conductive material comprising at least one of the metals copper, gold, tin, lead, silver, antimony, aluminum, and bismuth.

13. The integrated device of claim 1, the integrated device comprising an insulating material being arranged between the circuit chip and the carrier substrate.

14. A memory device comprising:
a carrier substrate, the carrier substrate comprising a through hole and a contact sleeve, the contact sleeve being arranged such that an opening of the contact sleeve and the through hole at least in part overlap;
an integrated memory circuit above the carrier substrate, the integrated memory circuit comprising a contact pad on a surface facing the carrier substrate, the contact pad being arranged such that the contact pad and the opening of the contact sleeve at least in part overlap; and
a conductive material, the conductive material electrically connecting the contact pad to the contact sleeve.

15. The memory device of claim 14, the contact sleeve comprising a coating, the coating comprising a weldable material.

16. The memory device of claim 14, the conductive material comprising a welding seam.

17. The memory device of claim 14, the memory device comprising a projecting contact, the projecting contact being arranged on the contact pad and at least in part in the through hole.

18. The memory device of claim 17, the projecting contact comprising a coating, the coating comprising a weldable material.

19. The memory device of claim 17, the projecting contact touching the contact sleeve along a continuous line.

20. The memory device of claim 19, the conductive material comprising a welding seam at least along a part of the continuous line.

21. The memory device of claim 17, the projecting contact comprising at least one of the metals copper, gold, tin, lead, silver, antimony, aluminum, and bismuth.

22. The memory device of claim 14, the contact sleeve comprising at least one of the metals copper, gold, tin, lead, silver, antimony, aluminum, and bismuth.

23. The memory device of claim 14, the through hole being at least partially filled with the conductive material.

24. The memory device of claim 23, the conductive material comprising a soldering metal.

25. The memory device of claim 23, the conductive material comprising at least one of the metals copper, gold, tin, lead, silver, antimony, aluminum, and bismuth.

26. The memory device of claim 14, the memory device comprising an insulating material being arranged between the integrated memory circuit and the carrier substrate.

27. The memory device of claim 14, the memory device comprising at least one further integrated memory circuit.

28. A memory module comprising:
a circuit board, the circuit board comprising a through hole and a contact sleeve, the contact sleeve being arranged such that an opening of the contact sleeve and the through hole at least in part overlap;
an integrated memory circuit above the circuit board, the integrated memory circuit comprising a contact pad on a surface facing the circuit board, the contact pad being arranged such that the contact pad and the opening of the contact sleeve at least in part overlap; and
a conductive material, the conductive material electrically connecting the contact pad to the contact sleeve.

29. The memory module of claim 28, the conductive material comprising a welding seam.

30. The memory module of claim 28, the memory module comprising a projecting contact, the projecting contact being arranged on the contact pad and at least in part in the through hole.

31. The memory module of claim 30, the projecting contact comprising at least one of the metals copper, gold, tin, lead, silver, antimony, aluminum, and bismuth.

32. The memory module of claim 28, the contact sleeve comprising at least one of the metals copper, gold, tin, lead, silver, antimony, aluminum, and bismuth.

33. The memory module of claim 28, the through hole being at least partially filled with the conductive material.

34. The memory module of claim 33, the conductive material comprising a soldering metal.

35. The memory module of claim 33, the conductive material comprising at least one of the metals copper, gold, tin, lead, silver, antimony, aluminum, and bismuth.

36. The memory module of claim 28, the memory module comprising an insulating material being arranged between the integrated memory circuit and the circuit board.

37. The memory module of claim 28, the memory module comprising at least one further integrated memory circuit, the further integrated memory circuit being arranged above the integrated memory circuit.

38. A circuit system comprising:
a circuit board, the circuit board comprising a through hole and a contact sleeve, the contact sleeve being arranged such that an opening of the contact sleeve and the through hole at least in part overlap;
an integrated circuit chip above the circuit board, the integrated circuit chip comprising a contact pad on a surface facing the circuit board, the contact pad being arranged such that the contact pad and the opening of the contact sleeve at least in part overlap; and
a conductive material, the conductive material electrically connecting the contact pad to the contact sleeve.

39. The circuit system of claim 38, the conductive material comprising a welding seam.

40. The circuit system of claim 38, the circuit system comprising a projecting contact, the projecting contact being arranged on the contact pad and at least in part in the through hole.

41. The circuit system of claim 40, the projecting contact comprising at least one of the metals copper, gold, tin, lead, silver, antimony, aluminum, and bismuth.

42. The circuit system of claim 38, the contact sleeve comprising at least one of the metals copper, gold, tin, lead, silver, antimony, aluminum, and bismuth.

43. The circuit system of claim 38, the through hole being at least partially filled with the conductive material.

44. The circuit system of claim 38, the conductive material comprising a soldering metal.

45. The circuit system of claim 38, the conductive material comprising at least one of the metals copper, gold, tin, lead, silver, antimony, aluminum, and bismuth.

46. The circuit system of claim 38, the memory module comprising an insulating material being arranged between the integrated circuit chip and the circuit board.

47. A method of fabricating an electrical contacting of an integrated circuit to a carrier substrate comprising the processes of:
providing an integrated circuit comprising a contact pad on a surface of the integrated circuit;
providing the carrier substrate with a through hole;
providing a contact sleeve such that an opening of the contact sleeve and the through hole at least in part overlap;
stacking the integrated circuit on the carrier substrate such that the contact pad and the opening of the contact sleeve at least in part overlap; and
contacting the contact pad to the contact sleeve.

48. The method of claim 47, the method comprising prior to the stacking a providing of a projecting contact on the contact pad of the integrated circuit, and during stacking the projecting contact is at least partially inserted into the through hole.

49. The method of claim 48, the providing of the projecting contact being carried out by using galvanic deposition.

50. The method of claim 48, the providing of the projecting contact being carried out by using melting a wire.

51. The method of claim 48, the providing of the projecting contact being carried out by using depositing a material portion in a liquid state, the projecting contact being formed by the solidified material portion.

52. The method of claim 48, the providing of the projecting contact comprising a coating of the projecting contact with a weldable material.

53. The method of claim 48, the contacting of the contact pad to the contact sleeve being carried out by using welding the projecting contact to the contact sleeve.

54. The method of claim 53, the welding being carried out by using laser welding.

55. The method of claim 53, the welding being carried out by using ultrasonic welding.

56. The method of claim 47, the contacting of the contact pad to the contact sleeve being carried out by using welding.

57. The method of claim 56, the providing of the contact sleeve comprising a coating of the inner wall of the sleeve with a weldable material.

58. The method of claim 56, the welding being carried out by using laser welding.

59. The method of claim 56, the welding being carried out by using ultrasonic welding.

60. The method of claim 47, the contacting of the contact pad to the contact sleeve being carried out by gluing, using a conductive adhesive.

61. The method of claim 47, the contacting of the contact pad to the contact sleeve being carried out by using at least a partially filling of the through hole with a soldering metal.

62. The method of claim 61, the filling being carried out by using wave soldering.

63. The method of claim 61, the filling comprising a depositing of a soldering paste in an area of the contact pad and a melting the soldering paste.

64. The method of claim 61, the filling comprising a depositing of a soldering paste in an area of the contact sleeve and a melting the soldering paste.

65. The method of claim 47, the method comprising a filling of an intermediate space between the integrated circuit and the carrier substrate with an insulating material.

66. The method of claim 47, the method comprising an inspecting of the contact of the contact pad to the contact sleeve, and the method comprising, in the case of a faulty contact, a renewed contacting of the contact pad to the contact sleeve.
